(19) United States
(12) Patent Application Publication
(10) Pub. No.: US 2008/0233256 A1
(43) Pub. Date: Sep. 25, 2008

(54) METHOD AND APPARATUS FOR POPCORN POPPING IN A REDUCED PRESSURE ENVIRONMENT

(76) Inventor: Paul V. Quinn, Allentown, PA (US)

Correspondence Address: DESIGN IP, P.C., 5100 W. TILGHMAN STREET, SUITE 205, ALLENTOWN, PA, 18104, US

(21) Appl. No.: 11/690,417

(22) Filed: Mar. 23, 2007

(51) Int. Cl. A23L 1/18; A47J 27/00

(52) U.S. Cl. 426/450; 99/323.5

(57) ABSTRACT

A popcorn popping device and method in which popcorn is popped in a sealable container at sub-ambient pressure. A vacuum source connected to the sealed chamber of the container reduces the pressure in the chamber prior to the popping process and maintains the reduced pressure throughout the popping process. The vacuum source can be attached to the exterior of the container or positioned remotely. Embodiments of the device include a stove-top version, intended for use with a heating element, a microwave version, or a commercial-style version in which popcorn is popped in a kettle that is positioned within a sealable chamber.

### FIELD OF INVENTION

This invention relates to a method and an apparatus that enables larger output volume and thus more efficient popcorn popping.

### BACKGROUND OF THE INVENTION

Popcorn is a popular, widely recognized snack food. It is known that providing a reduced-pressure environment during popcorn popping can increase average popped kernel volume and reduce the number of un-popped kernel, both of which are desirable. The prior art teaches various means for providing a reduced-pressure environment, including providing a sealable popcorn popping chamber that is intended to be heated atop a radiant heating element. Pressure reduction is provided by a vacuum source that is connected to the container and operated during the heating step.

### SUMMARY OF THE INVENTION

In one respect, the invention comprises a method for popping popcorn. Un-popped popcorn kernels are placed into a chamber that is connected to a vacuum source and the chamber is sealed. The vacuum source is operated to reduce the pressure in the chamber. The chamber is placed in the cooking area of a microwave oven and is heated with microwaves until at least a majority of the popcorn kernels have popped. The connection between the chamber and the vacuum source is maintained during the heating step.

In another respect, the invention comprises an apparatus for popping popcorn within a microwave oven, the microwave oven comprising an enclosed cooking area defined by a plurality of walls and a door. The apparatus comprises a vacuum system including a vacuum source. The apparatus also includes a container having a chamber that is connected to the vacuum source. The container has a closed position in which the chamber is sealed except for the connection to the vacuum source. The vacuum system is configured to enable the vacuum source to operate and maintain a connection with the chamber when the container is located in the enclosed cooking area and microwaves are applied to the container.

In yet another respect, the invention comprises an apparatus for popping popcorn, including a chamber having a door. The chamber is substantially air-tight when the door is in a closed position. The apparatus also includes a container located within the chamber and a heat source for heating the container. Also included is a vacuum system having a vacuum source that is connected to the chamber. The vacuum system is adapted to reduce the pressure in the chamber from ambient pressure to a pre-selected pressure when the chamber is in a closed position.

### BRIEF DESCRIPTION OF THE DRAWINGS

The present invention will hereinafter be described in conjunction with the appended drawing figures wherein like numerals denote like elements.

FIG. 1 is a flow diagram showing the steps involved in the disclosed method;

FIG. 2 is a block diagram indicating the components of an embodiment with a container with sealable chamber and remote vacuum source;

FIG. 3 is a plan view of the components of a popcorn popping apparatus comprising a container with sealable chamber and remote vacuum source;

FIG. 4 is a cross-section showing a container with sealable chamber;

FIG. 5 is a plan view of a microwave popcorn popping apparatus comprising a container with sealable chamber and remote vacuum source;

FIG. 6 is a cross-section of a microwave popcorn popping apparatus container;

FIG. 7 is a plan view of a commercial style popcorn popping apparatus comprising an internal, unsealed container within a sealable chamber with remote vacuum source;

FIG. 8 is a cross-section of a sealable chamber for a commercial style popcorn popping apparatus; and

FIG. 9 is a block diagram of a popcorn popping apparatus comprising a container with sealed chamber and an integral vacuum source.

### DETAILED DESCRIPTION OF THE PREFERRED EMBODIMENTS

The ensuing detailed description provides preferred exemplary embodiments only, and is not intended to limit the scope, applicability, or configuration of the invention. Rather, the ensuing detailed description of the preferred exemplary embodiments will provide those skilled in the art with an enabling description for implementing the preferred exemplary embodiments of the invention. It being understood that various changes may be made in the function and arrangement of elements without departing from the spirit and scope of the invention.

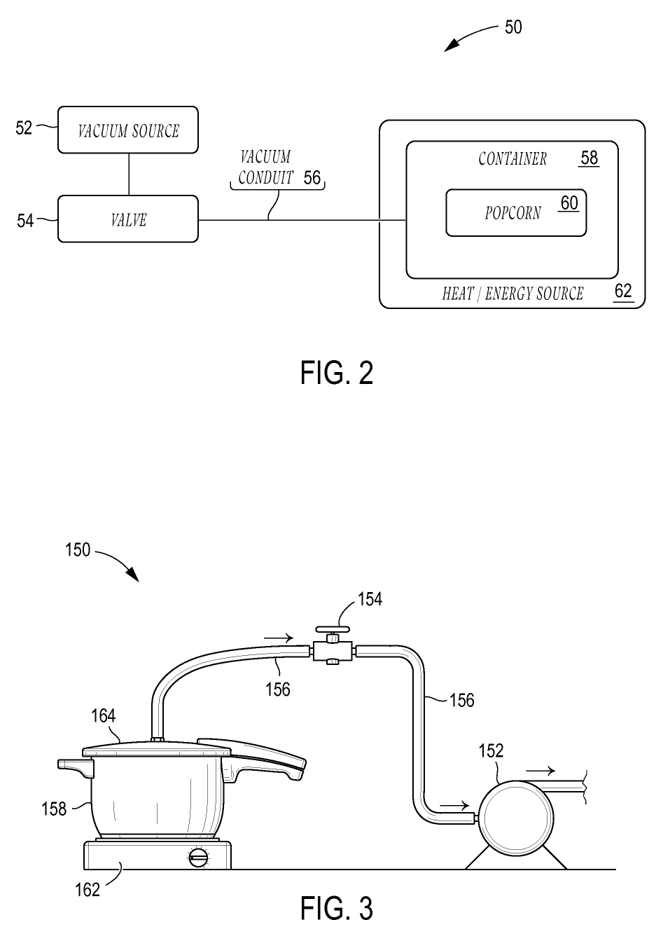

Shared elements among the disclosed embodiments will be represented by reference numerals increased by factors of 100. For example, vacuum source 52 in FIG. 2 corresponds to vacuum source 152 in FIG. 3. Some shared elements in later-described embodiments may be numbered in the figures without being separately referenced in the specification.

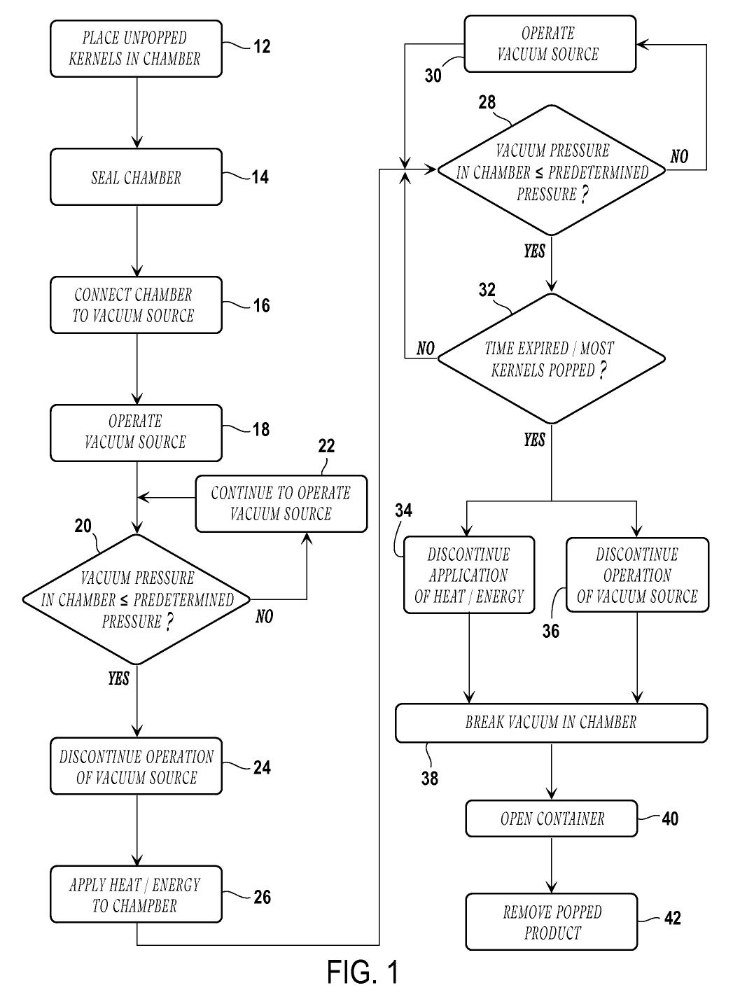

The flow diagram of FIG. 1 shows a preferred method of popcorn popping that results in increased popcorn flake size and total popcorn expansion volume, while decreasing the fraction of un-popped kernels. A container with sealable chamber, a vacuum source, un-popped popcorn kernels and a heat/energy source are required to perform the method. This method can be implemented using many different apparatus configurations.

Un-popped kernels are placed in the container chamber (step 12). The chamber is then sealed (step 14) and the chamber is connected to a vacuum source (step 16). The vacuum source is operated (step 18) and the pressure in the chamber is monitored to determine if it has been reduced to a pre-selected vacuum pressure (step 20). If the vacuum pressure is not equal to or less than a pre-selected pressure, the vacuum source operation is continued (step 22) until the pre-selected vacuum pressure has been reached. It has been found that a vacuum pressure of about −15 in Hg or lower achieves excellent results. For the purposes of the specification and claims, the term “vacuum pressure” means gauge pressure.

When the chamber vacuum pressure is equal to or less than the pre-selected pressure, the operation of the vacuum source is discontinued (step 24) and heat/energy is applied to the chamber (step 26) and thereby the un-popped kernels therein. Heat/energy can be applied to the chamber using any suitable heat or energy source, such as, for example, providing a stove-top heating element placed in close proximity to the container, applying microwave energy to the chamber, or by integrating a heating element into the container itself.

During application of the heat/energy to the chamber (step 26) the vacuum pressure in the chamber continues to be monitored (step 28) and, if the vacuum pressure rises above the pre-selected pressure (e.g., −15 in Hg), the vacuum source is re-activated (step 30). The heat popping process progress/status may be timed or monitored based on a drop in popping rate (step 32). If the time is not expired (or if there continues to be a high popping rate), the heat/energy continues to be applied (step 26) and vacuum pressure continues to be monitored (step 28) and maintained (step 30). Once the time has expired (or the popping rate indicates most of the kernels are popped), the heat/energy and vacuum sources are discontinued (steps 34 & 36). The final steps involve breaking the vacuum in the chamber (step 38), opening the container (step 40) and removing the popped corn (step 42). Alternatively, the vacuum source can be operated continuously, from step 18 through step 36. Under this alternative method, steps 24, 28 and 30 are omitted.

FIG. 2 shows a block diagram of a preferred apparatus 50 for implementing the method described above. The apparatus 50 includes a container 58 having a sealable chamber connected to a remote vacuum source 52. Un-popped popcorn 60 is placed in the container 58 for popping. The container 58 is connected to a remote vacuum source 52 through a vacuum conduit 56 having a valve 54. A radiant heat/energy source 62 is applied directly to the container 58.

A first embodiment of an apparatus 150 including a container with sealable chamber 158 and remote vacuum source 152 is shown in FIGS. 3 & 4. Un-popped popcorn kernels 160 are placed in container 158 and the container 158 sealed using cover 164, which includes additional seal 166. Container 158 and cover 164 could be fabricated from any material used in conventional stove-top cooking utensils, such as cast iron, cast or drawn aluminum or other appropriate metals. The overall configuration of container 158 in this embodiment is similar to that of a conventional pressure cooker. The cover 164 and container enable use of a seal 166 to provide the sealing required to allow creation of vacuum pressure within the container. The seal 166 is made from an appropriately heat-resistant elastomer, such as a fluorocarbon or silicone, for example.

After the container 158 is sealed, it is connected to a vacuum source 152. Conduit 156, valve 154 and fitting 168 make up the fluid connection between the container 158 and vacuum source 152. In a closed position, the valve 154 preferably provides a fluid path to the container 158 from the vacuum source 152. In an open position, the valve 154, proves a fluid connection between the container 158 and the ambient air surrounding the apparatus 50.

The vacuum source 152 is operated with the valve 154 positioned to allow fluid flow from the vacuum source 152 to the container 158 until the vacuum pressure in the container is equal to or less than a pre-selected pressure (e.g., −15 in Hg). Heat is then applied by heat/energy source 162. The vacuum source 152 continues to operate as needed to maintain the pre-selected vacuum pressure during the entire heating step.

Un-popped popcorn kernels 160 (shown schematically) may be plain or oiled when placed in container 158. If it is plain, a screen 170 is preferably used to minimize burning and provide uniform heating of the un-popped popcorn kernels 160.

Heat/energy source 162 could be a simple hot plate or electric or gas oven burner. Heat is applied while the vacuum pressure is maintained by the vacuum source 152 until popping is complete. When the popping is judged either by time or significantly reduced popping frequency to be complete, operation of the heat/energy source 162 and vacuum source 152 are discontinued. Valve 154 is positioned to allow fluid flow to ambient air to break the vacuum in the container 158, which enables the container 158 to be opened more easily. The finished popcorn product can then be removed. The use of this method and apparatus results in more volume of popped product and a reduction of un-popped kernels thus providing a more efficient popping process.

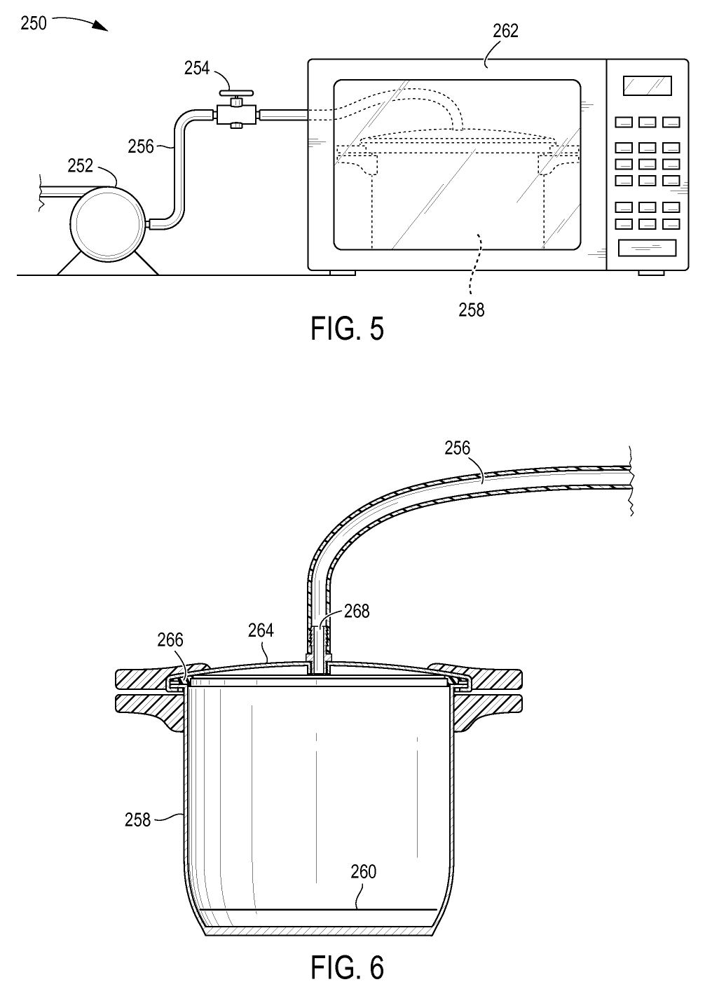

FIGS. 5 and 6 show a popping apparatus 250 with a remote vacuum source 252, which is adapted for use with a microwave oven as the heat/energy source 262. Components of the vacuum system include the vacuum source 252, vacuum conduit 256 and valve 254. The conduit 256 connects to both the container 258 and vacuum source 252 and extends through one wall of the microwave 262. Sealable container 258 and its components complete the apparatus.

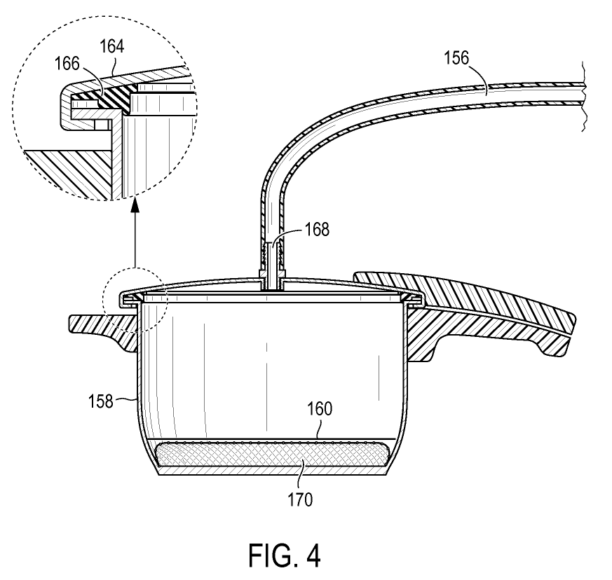

The method of FIG. 1 is followed by placing un-popped corn 260 (shown schematically) in container 258 and sealing the container. The drawing shows container 258 with cover 264 and seal 266 similar to the container 58 of the first embodiment (see FIG. 4). The configuration shown is an illustrative way to achieve a sealed container. The use of the microwave heat/energy source 262 requires the components of container 158 to be fabricated of rigid, non-metallic, temperature resistant materials commonly used in microwave-proof kitchenware such as polypropylene or non-metallic ceramics, for example. Container 258 is preferably re-sealable and, as such, is reusable. In addition, the container 258 and lid 264 could be similar in depth (or even symmetrical) instead of the relatively deep container 258 and shallow lid 264 shown in FIGS. 5 and 6.

The valve 254 provides the same function as valve 154 in FIG. 3 and is positioned to allow fluid flow from the vacuum source 252 to the container 258 when the vacuum source 252 is operated.

In this embodiment the vacuum source 252 is a vacuum pump and it is operated until the vacuum pressure in the container 258 is within a preferred range. The container 258 and its contents are heated by operating the microwave 262. The vacuum source 252 is operated during the heating step for the portions of time necessary to maintain the vacuum pressure within the pre-selected range or, can be operated continuously during the heating step.

In this embodiment the preferred initial and maximum maintained vacuum pressure in the container 258 will be no greater than −15 in Hg. When the popcorn popping is complete, judged either by time or significantly reduced popping frequency, operation of the heat source 262 and vacuum source 252 is discontinued. Valve 254 is positioned to allow fluid flow to atmosphere and break the vacuum in the container 258. The finished popcorn product can then be removed.

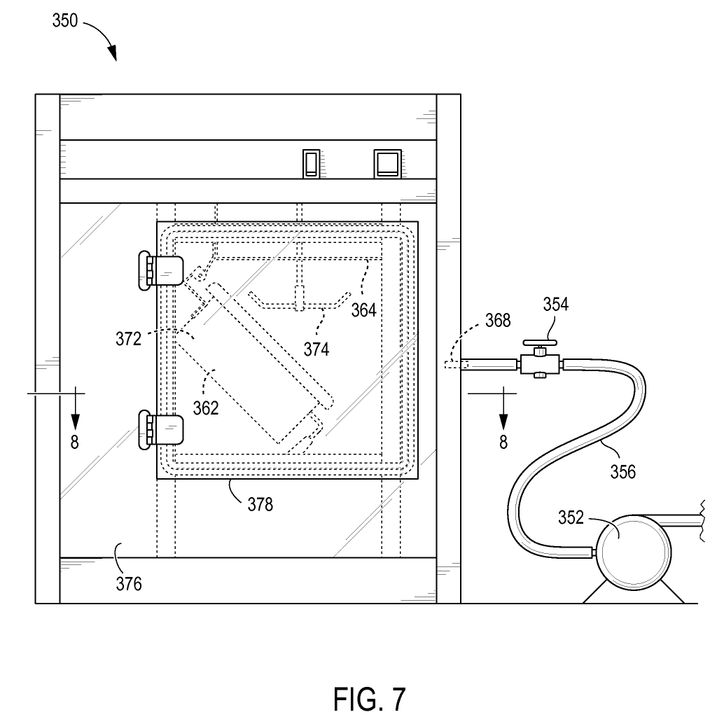

A commercial version of a popcorn popping apparatus 350 with remote vacuum source 352 is shown in FIG. 7. This embodiment is comprised of a larger chamber 376 which is substantially air-tight when door 378 is in a closed position. An unsealed container or kettle 372 is located within chamber 376 and contains an integral heat source 362. The apparatus also includes a vacuum source 352 connected to the chamber 376 by conduit 356 through valve 354 and fitting 368. The cover 364 retains popped corn in container 372 when it is in the operational position. Stirring device 374 is operated to stir the un-popped kernels, not shown, during the heating cycle.

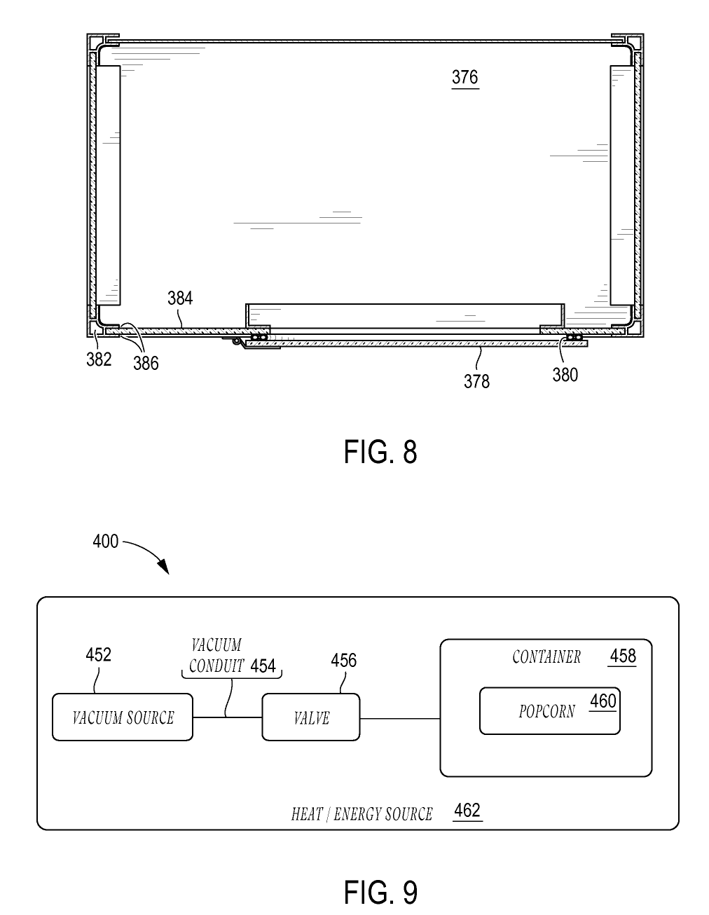

Other components required for the substantially air-tight construction of chamber 376 are illustrated in FIG. 8. A seal member 380 is provided for the periphery of door 378. Seal 380 is preferably made of a closed cell elastomer or other material capable of withstanding the vacuum pressure and designed with a specific door 378 closed position to provide appropriate compression and maintain the seal.

The wall members 384 and corner structures 382 are selected to provide adequate rigidity, retention and sealing capabilities. Acrylic, polycarbonate and HDPE sheet materials are readily available in thicknesses up to 1.0 inch. The thickness and material selection depend on wall member 384 dimensions and retention means. If transparency is not a functional requirement, metallic aluminum or stainless sheets could be used.

The corner structures 382 are preferably stainless or aluminum extrusions or rolled sections. Sealant 386, silicone or other appropriate air curing, semi flexible sealant, may be included along the interface between the wall member and corner structure 382 to reduce air leakage from the chamber 376.

Referring again to FIG. 7, oil and un-popped kernels, not shown, are measured into container 372, which is pivoted upward into position under cover 364. Door 378 is then closed. Vacuum source 352, which is connected to chamber 376 and is adapted to reduce the pressure in the chamber 376 when door 378 is closed and latched, is operated to reduce the pressure in the chamber 376 from ambient to a pre-selected pressure. When the vacuum pressure is equal or less than the pre-selected pressure, heat source 362 and stirring device 374 are operated. The vacuum source 352 is operated during the heating step for the portions of time necessary to maintain the pressure at or below the pre-selected pressure or can be operated continuously during the heating step. In this embodiment, the initial and maintained pre-selected pressure in the chamber 376 is preferably no greater than −15 in Hg.

When the popcorn popping is complete, judged either by time or significantly reduced popping frequency, operation of the heat source 362 and vacuum source 352 are discontinued. Valve 354 is positioned to allow fluid flow to atmosphere and break the vacuum in the chamber 376. Typically, for this type of application, the heating cycle would be repeated to produce large amounts of popped product for commercial purposes. After breaking the vacuum in the chamber 376, the heating cycle could be repeated and/or finished popcorn product be removed. The use of this method and apparatus results in more volume of popped product and a reduction of un-popped kernels thus providing a more efficient popping process.

FIG. 9 shows a block diagram of a popcorn popping apparatus 400 having a vacuum source 452, which is designed to be attached to the container 458. One application of this configuration would be a modified version of the microwave oven embodiment (discussed above), in which the vacuum source 452, valve 454 and conduit 456 would all be attached to the container 458, and thereby, positioned within the cooking chamber of the microwave oven during the heating step. In such a configuration, the vacuum source 452 would require a self-contained power source, such as a battery back (not shown). In addition, the battery pack would need to be shielded from microwave radiation. In addition, the vacuum source 452, valve 454 and conduit 456 would each preferably be made of materials that could withstand the microwave energy or, alternatively, be shielded from the microwave energy.

Other modifications of the embodiments described herein are possible. For example, any one of the valves 154, 254, 354 could be mounted directly onto the container 158, 258, 358. In addition, a pressure-sensitive switch could be provided, which measures the pressure in the conduit 156, 256, 356 or container 158, 258, 358 and switches the vacuum source 152, 252, 352 off when the pressure drops to a pre-selected minimum pressure (e.g. −30 in Hg) and regulator that would be set to switch the vacuum source 152, 252, 352 back on again when the pressure rises to the pre-selected maximum pressure.

It is recognized by those skilled in the art, that changes may be made to the above-described embodiments of the invention without departing from the broad inventive concept thereof. It is understood, therefore, that this invention is not limited to the particular embodiments disclosed but is intended to cover all modifications which are in the spirit and scope of the invention.

1. A method for popping popcorn comprising:
placing un-popped popcorn kernels into a chamber that is connected to a vacuum source;
sealing the chamber;
placing the chamber in a cooking area of a microwave oven;
operating the vacuum source to reduce the pressure in the chamber;
heating the chamber with microwaves until at least a majority of the popcorn kernels have popped; and
maintaining a connection between the chamber and the vacuum source during the heating step.

2. The method of claim 1, wherein the operating step comprises operating the vacuum source prior to the heating step.

3. The method of claim 2, wherein the operating step further comprises operating the vacuum source during at least a portion of the heating step.

4. The method of claim 3, wherein operating the vacuum source during at least a portion of the heating step further comprises maintaining a pressure in the chamber throughout the heating step that is no greater than a pre-selected pressure, the pre-selected pressure being less than 1 in Hg.

5. The method of claim 1, wherein the operating step comprises reducing the pressure in the chamber to no more than −15 in Hg.

6. The method of claim 5, wherein the operating step further comprises maintaining a pressure of no greater than −15 in Hg during the heating step.

7. An apparatus for popping popcorn within a microwave oven, the microwave oven comprising an enclosed cooking area defined by a plurality of walls and a door, the apparatus comprising:
a vacuum system including a vacuum source; and
a container having a chamber that is connected to the vacuum source, the container having a closed position in which the chamber is sealed except for the connection to the vacuum source; and
wherein the vacuum system is configured to enable the vacuum source to operate and maintain the connection with the chamber when the container is located in the enclosed cooking area and microwaves are applied to the container.

8. The apparatus of claim 7, wherein the vacuum system further comprises a conduit that is connected to both the chamber and the vacuum source and extends through one of the plurality of walls.

9. The apparatus of claim 7, wherein the vacuum system further comprises a power source for the vacuum source, the power source and the vacuum source being shielded from the microwaves.

10. The apparatus of claim 7, the vacuum system further comprising a valve relieves vacuum pressure in the chamber when the valve is opened.

11. The apparatus of claim 7, wherein the vacuum source and the container are adapted to reduce the pressure in the chamber from ambient pressure to a pre-selected pressure when the chamber is in the closed position and the vacuum source is operated.

12. The apparatus of claim 11, wherein the vacuum source and the container are adapted to maintain the pre-selected pressure in the chamber during a popcorn popping cycle in which popcorn kernels located in the chamber are popped.

13. The apparatus of claim 11, wherein the pre-selected pressure is no greater than −15 in Hg.

14. The apparatus of claim 7, wherein the vacuum source comprises a vacuum pump.

15. The apparatus of claim 7, wherein the container is rigid.

16. The apparatus of claim 14, wherein the chamber is re-sealable.

17. An apparatus for popping popcorn comprising:
a chamber having a door, the chamber being substantially air-tight when the door is in a closed position;
a container located within the chamber;
a heat source for heating the container; and
a vacuum system including a vacuum source that is connected to the chamber;
wherein the vacuum system is adapted to reduce the pressure in the chamber from ambient pressure to a pre-selected pressure when the chamber is in a closed position.

18. The apparatus of claim 17, wherein the container comprises a popcorn-popping kettle.

19. The apparatus of claim 17, wherein the chamber comprises a plurality of walls and at least some of the plurality of walls are transparent.

20. The apparatus of claim 17, wherein the pre-selected pressure is no greater than −15 in Hg.
